(19) United States
(12) Patent Application Publication
(10) Pub. No.: US 2017/0068736 A1
(43) Pub. Date: Mar. 9, 2017

(54) RETURNING FILTERED SOCIAL MEDIA CONTENT TO A DATA STREAM

(71) Applicant: International Business Machines Corporation, Armonk, NY (US)

(72) Inventors: Kristina Beckley, Carlisle, MA (US); Michelle L. Cooper, Boxborough, MA (US); Ché L. McKenna, Dublin (IE); Ruairi O'Shea, Drogheda (IE)

(21) Appl. No.: 14/844,300

(22) Filed: Sep. 3, 2015

(51) Int. Cl. G06F 17/30; H04L 29/06; H04L 29/08

(52) U.S. Cl. CPC G06F 17/30867; H04L 67/02; H04L 67/42; G06F 17/30516

(57) ABSTRACT

An approach for filtering social media content. The approach receives a request to filter a plurality of content from a data stream during one or more scheduled time frames. The approach monitors the data stream during the one or more scheduled time frames for one or more identifiers of the plurality of content to be filtered. Responsive to determining at least one of the one or more identifiers exist in the data stream, the approach filters the plurality of content from the data stream. The approach receives a notification that the one or more scheduled time frames has ended. Responsive to receiving a notification that the one or more scheduled time frames has ended, the approach retrieves the plurality of content filtered from the data stream. The approach returns the plurality of content to the data stream.

### BACKGROUND

The present invention relates generally to social media, and more particularly, to returning filtered social media content to a data stream based on subject relevancy and scheduled time frames.

Social media networks may filter content (e.g. links to articles, news items, video clips, tweets, likes, links to other websites, status updates, pictures, network user comments or posts, reposts of other user posts, etc.) presented to a user based on the content's popularity when determining whether the content is relevant to the user. These social media networks may also use ratings associated with the content to filter content displayed to the user. Typically, a user can manually filter out irrelevant or unwanted content when perusing a social media network.

### SUMMARY

Aspects of the present invention provide a method, computer program product, and a computer system for filtering social media content, in accordance with an embodiment of the present invention. The method includes receiving, by one or more computer processors, a request to filter a plurality of content from a data stream during one or more scheduled time frames. The method includes monitoring, by one or more computer processors, the data stream during the one or more scheduled time frames for one or more identifiers of the plurality of content to be filtered. Responsive to determining at least one of the one or more identifiers exist in the data stream, the method includes filtering, by one or more computer processors, the plurality of content from the data stream. The method includes receiving, by one or more computer processors, a notification that the one or more scheduled time frames has ended. Responsive to receiving a notification that the one or more scheduled time frames has ended, the method includes retrieving, by one or more computer processors, the plurality of content filtered from the data stream. The method includes returning, by one or more computer processors, the plurality of content to the data stream.

### BRIEF DESCRIPTION OF THE DRAWINGS

FIG. 1 is a functional block diagram illustrating a data processing environment, in accordance with an embodiment of the present invention.

FIG. 2 is a flowchart illustrating operational steps of a content filtering program, in accordance with an embodiment of the present invention.

FIG. 3 is a block diagram depicting components of a data processing system (such as the server of FIG. 1), in accordance with an embodiment of the present invention.

### DETAILED DESCRIPTION

Embodiments of the present invention recognize a user's prioritized interests in social media content may change sporadically, and manually filtering irrelevant or unwanted social media content can be time consuming and cumbersome.

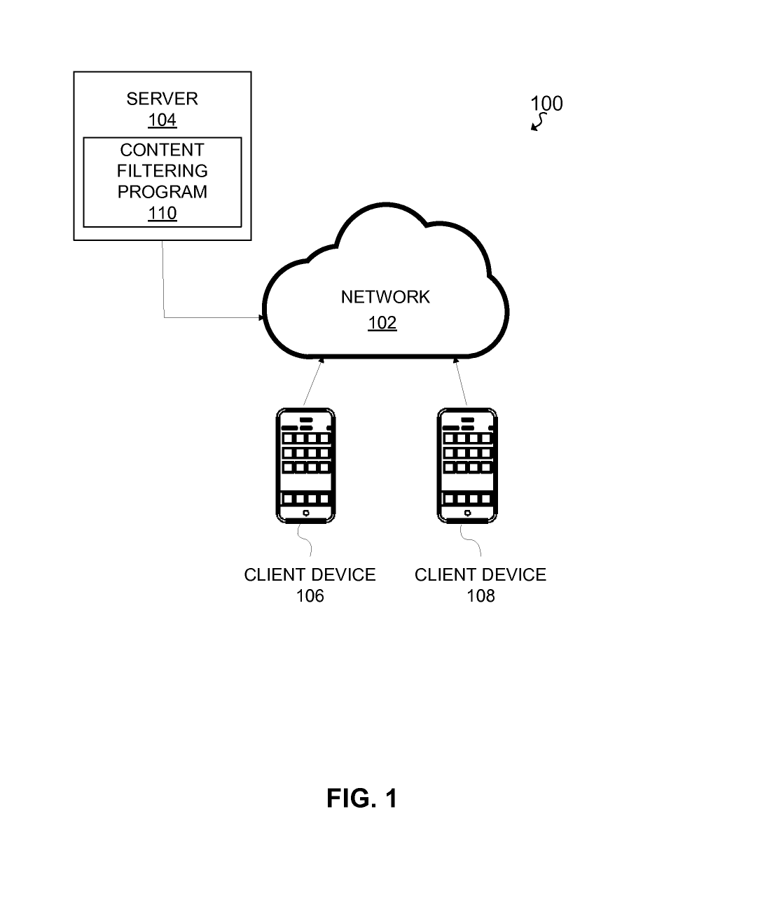

Embodiments of the present invention provide the capability to filter social media content based, at least in part, on subject relevancy during scheduled time frames. Embodiments of the present invention provide the capability to return filtered social media content to a data stream based, at least in part, on subject relevancy and scheduled time frames. Embodiments of the present invention provide the capability to filter social media content as described below with references to FIGS. 1-3.

Implementation of such embodiments may take a variety of forms, and exemplary implementation details are discussed subsequently with reference to the Figures.

FIG. 1 is a functional block diagram illustrating a data processing environment 100, in accordance with an embodiment of the present invention. FIG. 1 provides only an illustration of one implementation and does not imply any limitations with regard to the environments in which different embodiments may be implemented. Many modifications to the depicted environment may be made by those skilled in the art without departing from the scope of the invention as recited by the claims. Data processing environment 100 includes network 102, server 104, which operates content filtering program 110, and multiple client devices, such as client device 106 and client device 108.

In one embodiment, network 102 can be, for example, a local area network (LAN), a telecommunications network, a wide area network (WAN), such as the Internet, a virtual local area network (VLAN), or any combination that can include wired, wireless, or fiber optic connections. Network 102 can also include wire cables, wireless communication links, fiber optic cables, routers, switches and/or firewalls. Network 102 interconnects server 104, client device 106, and client device 108. In general, network 102 can be any combination of connections and protocols capable of supporting communications between server 104, client device 106, client device 108, and content filtering program 110.

In one embodiment, server 104 is a web-based server hosting content filtering program 110, in accordance with an embodiment of the present invention. In one embodiment, server 104 can be a web server, a blade server, a mobile computing device, a laptop computer, a tablet computer, a netbook computer, a personal computer (PC), a desktop computer, or any programmable electronic device or computing system capable of receiving and sending data, via network 102, and performing computer-readable program instructions. In another embodiment, server 104 can be a data center, consisting of a collection of networks and servers providing an IT service, such as virtual servers and applications deployed on virtual servers, to an external party. In another embodiment, server 104 represents a computing system utilizing clustered computers and components (e.g., database server computer, application server computers, etc.) that act as a single pool of seamless resources, such as in a cloud computing environment, when accessed within data processing environment 100.

In some embodiments, server 104 can include a data storage repository (not shown) for storing data including, but not limited to, content (e.g. links to articles, news items, video clips, tweets, likes, links to other websites, status updates, pictures, network user comments or posts, reposts of other user posts, etc.) filtered by content filtering program 110. A data storage repository can be one of, a web server, a mobile computing device, a laptop computer, a tablet computer, a netbook computer, a personal computer (PC), a desktop computer, or any programmable electronic device or computing system capable of receiving, storing, and sending files and data, and performing computer readable program instructions capable of communicating with server 104, client device 106, and client device 108, via network 102. In other embodiments, a data storage repository can represent a virtual instance operating on a computing system utilizing clustered computers and components (e.g., database server computer, application server computers, etc.) that act as a single pool of seamless resources when accessed within data processing environment 100. In some embodiments, a single data storage repository may contain all available filtered content. In some other embodiments, content filtering program 110 may distribute available filtered content across one or more data storage repositories.

In one embodiment, server 104 includes content filtering program 110 for filtering social media content based, at least in part, on subject relevancy during scheduled time frames, and returning filtered social media content to a data stream based, at least in part, on the subject relevancy and the scheduled time frames. In some embodiments, content filtering program 110 receives a request to filter content received from a data stream for a scheduled time frame. The request may be to delay or ignore content to a feed for the scheduled time frame, wherein the feed may include an individual social media feed on a client device, such as client device 106 and client device 108, a social media news feed on a website viewed on a client device, or any other suitable social media feed capable of receiving, displaying, and updating social media content. Having received a request to filter content, content filtering program 110 monitors the data stream for identifiers of the content to be filtered from the data stream. Responsive to determining one or more identifiers of content scheduled to be filtered exists in the data stream, content filtering program 110 filters out the content requested to be delayed or ignored from the data stream. Content filtering program 110 displays the unfiltered content from the data stream in the feed. Content filtering program 110 may store the filtered content in a data storage repository. Content filtering program 110 receives a notification that the scheduled time frame ended. Responsive to receiving a notification that the scheduled time frame has ended, content filtering program 110 retrieves the filtered content. Content filtering program 110 returns the filtered content into the data stream. In an embodiment, content filtering program 110 displays in the feed the filtered content at the original times entered in the data stream. In another embodiment, content filtering program 110 displays in the feed the filtered content at the original times entered in the data stream, in which the filtered content contains a visual indicator to indicate where content filtering program 110 displayed the returned filtered content in the feed. In yet another embodiment, content filtering program 110 displays the returned filtered content in a group or list.

In some embodiments, content filtering program 110 operates on a central server, such as server 104, and can be utilized by one or more client devices, such as client device 106 and client device 108, via a mobile application download from the central server or a third-party application store, and executed on the one or more client devices. In another embodiment, content filtering program 110 may be a software-based program, downloaded from a central server, such as server 104, and installed on one or more client devices, such as client device 106 and client device 108. In yet another embodiment, content filtering program 110 can be utilized as a software service provided by a third-party cloud service provider (not shown).

In some embodiments, client device 106 and client device 108 are clients to server 104 and can be, for example, a desktop computer, a laptop computer, a tablet computer, a personal digital assistant (PDA), a smart phone, a thin client, or any other electronic device or computing system capable of communicating with server 104 through network 102. For example, client device 106 and client device 108 may be a mobile device capable of connecting to a network, such as network 102, to access the Internet and utilize social media networks. In other embodiments, client device 106 and client device 108 can be any suitable types of mobile devices capable of running mobile applications, including smart phones, tablets, slate, or any type of device that runs a mobile operating system. In yet other embodiments, client device 106 and client device 108 can represent virtual instances operating on a computing system utilizing clustered computers and components (e.g., database server computer, application server computers, etc.) that act as a single pool of seamless resources when accessed within data processing environment 100.

In yet another embodiment, client device 106 and client device 108 can include a user interface (not shown) for providing an end user with the capability to interact with content filtering program 110. For example, an end user may access content filtering program 110 through the user interface to enable content filtering program 110 to operate on the end user's device. A user interface refers to the information (such as graphic, text, and sound) a program presents to a user and the control sequences the user employs to control the program. In one embodiment, the user interface can be a graphical user interface (GUI). A GUI may allow users to interact with electronic devices, such as a keyboard and mouse, through graphical icons and visual indicators, such as secondary notations, as opposed to text-based interfaces, typed command labels, or text navigation.

In alternative embodiments, client device 106 and client device 108 can be any wearable electronic device, including wearable electronic devices affixed to eyeglasses and sunglasses, helmets, wristwatches, clothing, wigs, and the like, capable of sending, receiving, and processing content data. For example, client device 106 or client device 108 may be a wearable electronic device, such as a wristwatch, capable of filtering content in a stream and capable of displaying a filtered stream.

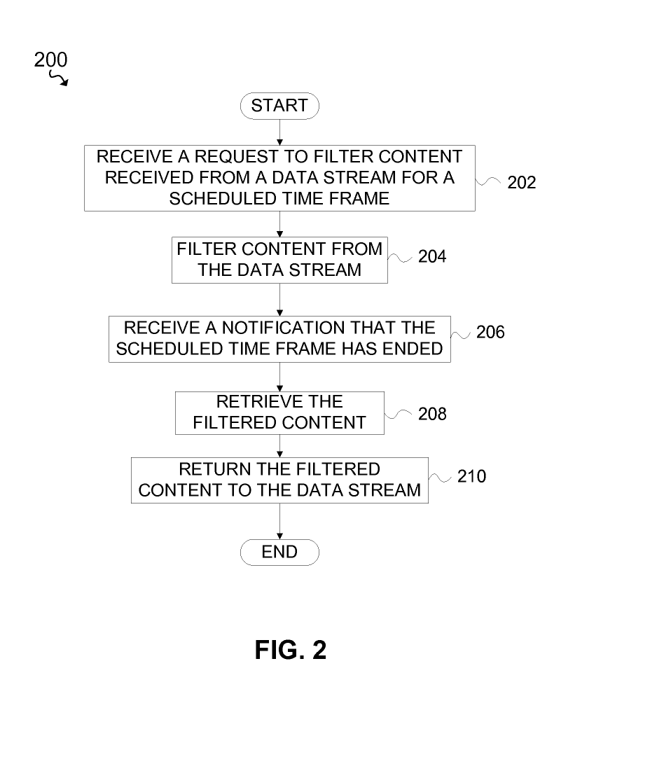

FIG. 2 is a flowchart illustrating operational steps of content filtering program 110, generally designated 200, in accordance with an embodiment of the present invention. In some embodiments discussed herein, devices, such as client device 106 and client device 108, can initiate content filtering program 110 by connecting to server 104 via network 102.

Content filtering program 110 receives a request to filter content received from a data stream for a scheduled time frame (202). In some embodiments, content filtering program 110 receives a request from a user to filter content received from the data stream for a scheduled time frame, where a scheduled time frame can be a pre-determined time frame, such as from 8:00 AM until 4:00 PM, in which the user wishes to filter incoming content on the user's client device, such as client device 106 and client device 108. In another embodiment, the scheduled time frame can be an automated machine learning-based schedule. In an embodiment, the data stream may be a collection of content such as links to articles, news items, video clips, tweets, likes, links to other websites, status updates, pictures, emails, network user comments or posts, or reposts of other user posts. Content filtering program 110 may receive the content from the data stream in chronological order. The feed may be a linear arrangement or organization of the data stream that is displayed on a client device, such as client device 106 or client device 108. In one embodiment, content filtering program 110 receives a request to filter different aspects of content in the data stream, such as the content's source (e.g. companies, bloggers, individual users, etc.), the content's topic (e.g. news reports, trending topics, etc.), or specific results of the content (e.g. game scores or winners, movie or television spoilers, etc.), such that is does not appear in the feed on the user's client device during the scheduled time frame. For example, content filtering program 110 may receive a request from a first user to filter content created by a second user and content of news reports mentioning corporation C.

In an embodiment, the received request may be to delay or ignore displaying content or its different aspects to the feed for a scheduled time frame. In one embodiment, a request to delay content may result in content not being displayed within a user's feed (e.g., notified) until the scheduled time frame expires, such that upon expiration of the scheduled time frame, the delayed content may be displayed (i.e., made visible again for listing) in a highlighted grouping at the top of the user's feed on a client device. In one embodiment, a request to ignore content may result in content created (i.e., posted) during the scheduled time frame not being displayed in the user's feed on a client device, such that upon expiration of the scheduled time frame, the ignored content, for example, is not made visible for listing on the user's client device, but instead is still available on a content originator's listing, page, feed, or forum where the content originated. In an embodiment, content filtering program 110 can receive the scheduled time frame from a user. In an embodiment, the scheduled time frame can be timer-based, in which content filtering program 110 filters and returns the filtered content ad hoc or returns the filtered content on a repeating scheduled time frame. For example, content filtering program 110 may filter and return the filtered content after 30 minutes, after 1 hour, after 24 hours, or every 2 hours. In an embodiment, the scheduled time frame can be calendar-based or event-based, in which content filtering program 110 filters and returns the filtered content ad hoc or returns the filtered content on a repeating timeframe. For example, content filtering program 110 may filter content and return the filtered content outside of work hours, after a user's meeting or appointment, or between 5 p.m. and 7 p.m. daily. In an embodiment, content filtering program 110 can receive a scheduled time frame based on events in a calendar application. For example, a user may schedule a vacation for 10 days and enter the dates for these days in a calendar application. Content filtering program 110 may begin filtering content from the data stream on the date of day 1 and end and return the filtered content to the data stream on the date of day 10. In another embodiment, the scheduled time frame can be automated machine learning-based, in which content filtering program 110 filters and returns content based, at least in part, on past user behavior. In yet another embodiment, the scheduled time frame can be manual control-based, in which content filtering program 110 receives a request to filter content and returns the filtered content to the data stream upon request. In another embodiment, content filtering program 110 may receive a request to delay or ignore different content, in which each requested content may be filtered for a different scheduled time frame. For example, the first user's request to filter the second user's content may be a request to delay the second user's content for the next 14 days, and the first user's request to filter content of news reports mentioning corporation C may be a request to ignore these news issues for 7 days. It should be appreciated that the scheduled time frame can be based on other methods known in the art.

Content filtering program 110 filters content from the data stream (step 204). In one embodiment, content filtering program 110 monitors the data stream for one or more identifiers (e.g. community names, tags, handles, content originators, content producers, etc.) of content scheduled to be filtered. In one embodiment, content filtering program 110 may extract the one or more identifiers from a delay content request or ignore content request, where the one or more identifiers can, without limitation, words, phrases, topics, subjects, senders, usernames, numbers, content originating from specific social media websites, and icons, etc., sufficient to identify and designate content to be filtered. In one embodiment, content filtering program 110 may utilize machine learning to determine content to be filtered based, at least in part, on content filtering history. In another embodiment, content filtering program 110 may utilize natural language processing known in the art to determine the one or more identifiers of content to be filtered. In one embodiment, content filtering program 110 may flag the one or more identifiers of content to be filtered from the data stream. For example, content filtering program 110 may monitor the data stream for one or more identifiers of the second user's content, such as the second user's name or handle. Responsive to determining identifiers of the second user's content, content filtering program 110 flags the name or handle of the second user to filter out the second user's content from the data stream. Content filtering program 110 may monitor the data stream for tags of news reports mentioning corporation C. Responsive to determining identifiers of corporation C's news reports, content filtering program 110 flags the tags to filter out the news reports from the data stream.

In one embodiment, responsive to determining one or more identifiers of content scheduled to be filtered exists in the data stream, content filtering program 110 filters out the content requested to be delayed or ignored from the data stream. In some embodiments, content filtering program 110 stores the filtered content in the data storage repository. In other embodiments, content filtering program 110 stores the filtered content locally on a device, such as client device 106 or client device 108. In some embodiments, content filtering program 110 does not delete the filtered content. In an embodiment, the content remains unfiltered in one or more streams not utilizing content filtering program 110. In another embodiment, the content remains unfiltered on the content originator's listing, page, or feed. In yet another embodiment, the content remains unfiltered on the forum where the content was originally posted. For example, a third user may still view the second user's content and news reports related to corporation C on the third user's stream.

In an embodiment, content filtering program 110 displays the unfiltered content of the data stream in the feed. Content filtering program 110 may not indicate the position where content filtering program 110 filtered the delayed or ignored content from the data stream. In some embodiments, content filtering program 110 does not display the number of content delayed or ignored in the feed. In an embodiment, content filtering program 110 displays the number of filtered content delayed and ignored. In another embodiment, content filtering program 110 displays the scheduled time frame of the delayed or ignored filtered content. For example, content filtering program 110 may display:
Delayed now: 10
Ignored this week: 25

In an embodiment, upon receiving a request to display the delayed or ignored filtered content before the scheduled time frame ends, content filtering program 110 displays the filtered content. In one embodiment, responsive to receiving a request to display the delayed or ignored filtered content before the scheduled time frame expires, content filtering program 110 returns the filtered content to the data stream to the user's feed on a client device, such as client device 106 and client device 108, utilizing methods found in step 210, which is discussed in further detail in paragraph [0028].

Content filtering program 110 receives a notification that the scheduled time frame has ended (step 206). In an embodiment, when the scheduled time frame ends, content filtering program 110 stops filtering content in the data stream. In an embodiment, the delay scheduled time frame and ignore scheduled time frame end simultaneously. In another embodiment, the delay scheduled time frame and ignore scheduled time frame end at different times. For example, the delay scheduled time frame to filter the second user's content ends at day 14 and the ignore scheduled time frame to filter news reports mentioning corporation C ends at day 7.

Responsive to receiving a notification that the scheduled time frame has ended, content filtering program 110 retrieves the filtered content (step 208). In some embodiments, content filtering program 110 retrieves the filtered content from a data storage repository. In other embodiments, content filtering program 110 retrieves the filtered content stored locally on a client device, such as client device 106 or client device 108.

Content filtering program 110 returns the filtered content to the data stream (step 210). In an embodiment, content filtering program 110 returns the filtered content to the data stream and displays the returned filtered content in the feed. In an embodiment, content filtering program 110 displays the returned filtered content in a grouping in the feed. In an embodiment, content filtering program 110 groups and displays the filtered content that was delayed. In an embodiment, content filtering program 110 groups and displays the filtered content that was ignored. In another embodiment, content filtering program 110 groups and displays the delayed filtered content and the ignored filtered content. Content filtering program 110 may display the grouping on a device, such as client device 106 and client device 108 in the same window as the feed. Content filtering program 110 may also display the grouping on a device in a window separate from the feed. In another embodiment, content filtering program 110 returns and displays the filtered content at the original times generated in the data stream. In another embodiment, content filtering program 110 returns and displays the filtered content at the original times generated in the stream, in which the filtered content contains a visual indicator to indicate where content filtering program 110 displayed the returned filtered content in the stream. In an embodiment, a visual indicator may comprise of text that is highlighted, bolded, italicized, underlined, indicated with symbols or markings, indicated in a different font or size, or indicated by other methods known in the art. In another embodiment, content filtering program 110 displays the delayed or ignored filtered content in a grouping and at the delayed or ignored filtered content's original time generated within the data stream.

In an embodiment, when content filtering program 110 receives a request to filter content by delaying the content to the feed, content filtering program 110 returns the filtered content to the data stream when the scheduled time frame expires and displays the filtered content in the feed. In another embodiment, when content filtering program receives a request to delay, content filtering program 110 notifies the user, when the delay scheduled time frame expires, which content was filtered from data stream. In another embodiment, when content filtering program 110 receives a request to delay, content filtering program 110 notifies the user, when the delay timeframe expires, which content was filtered from the data stream, and content filtering program 110 returns the filtered content to the data stream. For example, content filtering program 110 returns the second user's filtered content to the data stream at the end of day 14. Content filtering program 110 may notify the first user the delay scheduled time frame of 14 days ended. Content filtering program 110 may display the second user's content in a grouping in the same window as the first user's feed. Content filtering program 110 may return the second user's content to its original time within the feed and may highlight and bold the second user's returned filtered content.

In an embodiment, when content filtering program 110 receives a request to filter content by ignoring the content, content filtering program 110 does not return the filtered content to the data stream. In another embodiment, when content filtering program 110 receives a request to ignore the content, content filtering program 110 returns the filtered content to the data stream when the ignore scheduled time frame expires and displays the filtered content in the feed without notifying the user. For example, content filtering program 110 returns filtered content of news reports mentioning corporation C to the data stream at the end of day 7. Content filtering program 110 may return the news reports to their original times entered into the unfiltered data stream. Content filtering program 110 may display the news reports in the first user's feed without notifying the first user.

Having returned the filtered content to the data stream, content filtering program 110 ends.

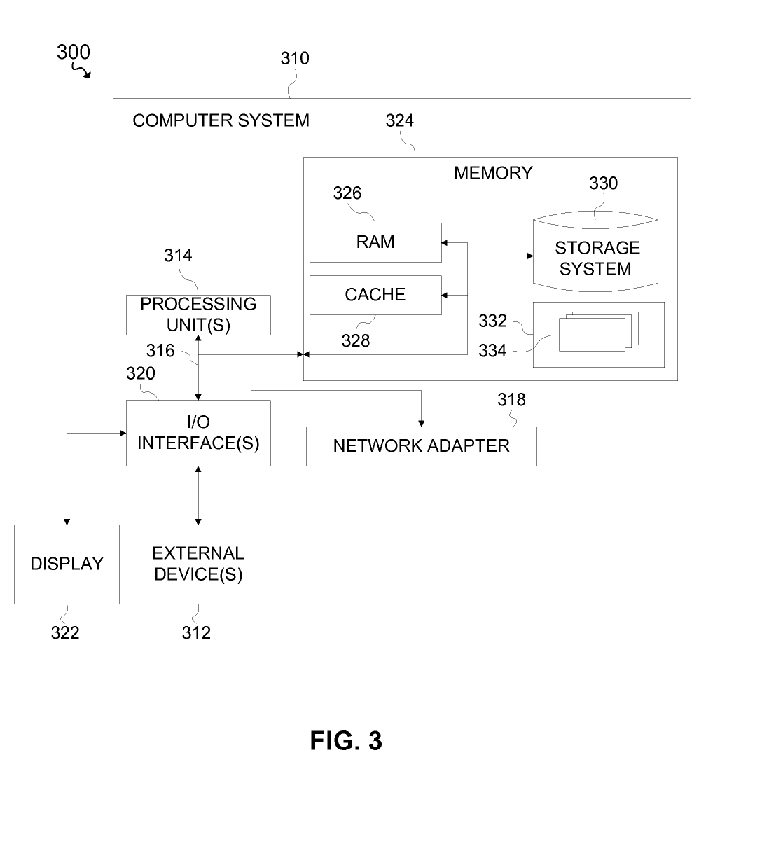

FIG. 3 is a block diagram depicting components of a data processing system, such as server 104 of data processing environment 100, generally designated 300, in accordance with an embodiment of the present invention. FIG. 3 provides only an illustration of one implementation and does not imply any limitations with regard to the environments in that different embodiments may be implemented. Many modifications to the depicted environment may be made.

In the illustrative embodiment, server 104 in data processing environment 100 is shown in the form of a general-purpose computing device, such as computer system 310. The components of computer system 310 may include, but are not limited to, one or more processors or processing unit 314, memory 324, and bus 316 that couples various system components including memory 324 to processing unit 314.

Bus 316 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system 310 typically includes a variety of computer system readable media. Such media may be any available media that is accessible by computer system 310, and it includes both volatile and non-volatile media, removable and non-removable media.

Memory 324 can include computer system readable media in the form of volatile memory, such as random access memory (RAM) 326 and/or cache memory 328. Computer system 310 may further include other removable/non-removable, volatile/non-volatile computer system storage media. By way of example only, storage system 330 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM, or other optical media can be provided. In such instances, each can be connected to bus 316 by one or more data media interfaces. As will be further depicted and described below, memory 324 may include at least one computer program product having a set (e.g., at least one) of program modules that are configured to carry out the functions of embodiments of the invention.

Program/utility 332, having one or more sets of program modules 334, may be stored in memory 324 by way of example, and not limitation, as well as an operating system, one or more application programs, other program modules, and program data. Each of the operating systems, one or more application programs, other program modules, and program data, or some combination thereof, may include an implementation of a networking environment. Program modules 334 generally carry out the functions and/or methodologies of embodiments of the invention as described herein. Computer system 310 may also communicate with one or more external device(s) 312 such as a keyboard, a pointing device, a display 322, etc., or one or more devices that enable a user to interact with computer system 310 and any devices (e.g., network card, modem, etc.) that enable computer system 310 to communicate with one or more other computing devices. Such communication can occur via Input/Output (I/O) interface(s) 320. Still yet, computer system 310 can communicate with one or more networks such as a local area network (LAN), a general wide area network (WAN), and/or a public network (e.g., the Internet) via network adapter 318. As depicted, network adapter 318 communicates with the other components of computer system 310 via bus 316. It should be understood that although not shown, other hardware and software components, such as microcode, device drivers, redundant processing units, external disk drive arrays, RAID systems, tape drives, and data archival storage systems may be used in conjunction with computer system 310.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, a special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

The terminology used herein is for the purpose of describing particular embodiments only and is not intended to be limiting of the invention. It should be appreciated that any particular nomenclature herein is used merely for convenience and thus, the invention should not be limited to use solely in any specific function identified and/or implied by such nomenclature. Furthermore, as used herein, the singular forms of “a”, “an”, and “the” are intended to include the plural forms as well, unless the context clearly indicates otherwise.

What is claimed is:

1. A method for filtering social media content, the method comprising:
receiving, by one or more computer processors, a request to filter a plurality of content from a data stream during one or more scheduled time frames;
monitoring, by one or more computer processors, the data stream during the one or more scheduled time frames for one or more identifiers of the plurality of content to be filtered;
responsive to determining at least one of the one or more identifiers exist in the data stream, filtering, by one or more computer processors, the plurality of content from the data stream;
receiving, by one or more computer processors, a notification that the one or more scheduled time frames has ended;
responsive to receiving a notification that the one or more scheduled time frames has ended, retrieving, by one or more computer processors, the plurality of content filtered from the data stream; and
returning, by one or more computer processors, the plurality of content to the data stream.

2. The method of claim 1, wherein the request to filter content from a data stream includes at least one of:
a request to delay displaying content from the data stream during the scheduled time frame;
a request to ignore content received from the data stream during the scheduled time frame; and
a request to filter one or more aspects of the plurality of content from the data stream, wherein the one or more aspects of the plurality of content include one or more of: a source of the plurality of content, a topic of the plurality of content, and a specific result of the plurality of content.

3. The method of claim 1, wherein the scheduled time frame includes at least one of:
a timer-based schedule;
a calendar-based schedule;
an event-based schedule utilizing a calendar application;
an automated machine learning-based schedule; and
a manual control-based schedule.

4. The method of claim 1, wherein filtering content from the data stream further comprises:
flagging, by one or more compute processors, the one or more identifiers of the plurality of content to be filtered from the data stream; and
displaying, by one or more computer processors, unfiltered content in the data stream.

5. The method of claim 1, wherein one or more identifiers include at least one of:
one or more community names;
one or more tags;
one or more handles;
one or more content originators; and
one or more content producers.

6. The method of claim 1, further comprises:
storing, by one or more computer processors, the plurality of content filtered from the data stream in a data storage repository.

7. The method of claim 1, wherein the plurality of content filtered from the data stream remains unfiltered on one or more of a content originator's listing, page, or feed, or on a forum wherein the plurality of content originated.

8. The method of claim 1, further comprises:
receiving, by one or more computer processors, a request to display the plurality of content filtered from the data stream before the scheduled time frame ends.

9. The method of claim 1, wherein returning the plurality of content to the data stream, further comprises:
displaying, by one or more computer processors, one or more returned delayed filtered content in a user's feed, wherein the one or more returned delayed filtered content includes a visual indicator.

10. A computer program product for filtering social media content, the computer program product comprising:
one or more computer readable storage media and program instructions stored on the one or more computer readable storage media, the program instructions comprising:
program instructions to receive a request to filter a plurality of content from a data stream during one or more scheduled time frames;
program instructions to monitor the data stream during the one or more scheduled time frames for one or more identifiers of the plurality of content to be filtered;
responsive to determining at least one of the one or more identifiers exist in the data stream, program instructions to filter the plurality of content from the data stream;
program instructions to receive a notification that the one or more scheduled time frames has ended;
responsive to receiving a notification that the one or more scheduled time frames has ended, program instructions to retrieve the plurality of content filtered from the data stream; and
program instructions to return the plurality of content to the data stream.

11. The computer program product of claim 10, wherein the request to filter content from a data stream includes at least one of:
a request to delay displaying content from the data stream during the scheduled time frame;
a request to ignore content received from the data stream during the scheduled time frame; and
a request to filter one or more aspects of the plurality of content from the data stream, wherein the one or more aspects of the plurality of content include one or more of: a source of the plurality of content, a topic of the plurality of content, and a specific result of the plurality of content.

12. The computer program product of claim 10, wherein the scheduled time frame includes at least one of:
a timer-based schedule;
a calendar-based schedule;
an event-based schedule utilizing a calendar application;
an automated machine learning-based schedule; and
a manual control-based schedule.

13. The computer program product of claim 10, wherein program instructions to filter content from the data stream further comprises:
program instructions to flag the one or more identifiers of the plurality of content to be filtered from the data stream; and
program instructions to display unfiltered content in the data stream.

14. The computer program product of claim 10, wherein one or more identifiers include at least one of:
one or more community names;
one or more tags;
one or more handles;
one or more content originators; and
one or more content producers.

15. The computer program product of claim 10, further comprises:
program instructions to store the plurality of content filtered from the data stream in a data storage repository.

16. The computer program product of claim 10, wherein the plurality of content filtered from the data stream remains unfiltered on one or more of a content originator's listing, page, or feed, or on a forum wherein the plurality of content originated.

17. The computer program product of claim 10, further comprises:
program instructions to receive a request to display the plurality of content filtered from the data stream before the scheduled time frame ends.

18. The computer program product of claim 10, wherein program instructions to return the plurality of content to the data stream, further comprises:
program instructions to display one or more returned delayed filtered content in a user's feed, wherein the one or more returned delayed filtered content includes a visual indicator.

19. A computer system for filtering social media content, the computer system comprising:
one or more computer readable storage media;
program instructions stored on at least one of the one or more computer readable storage media for execution by at least one of the one or more computer processors, the program instructions comprising:
program instructions to receive a request to filter a plurality of content from a data stream during one or more scheduled time frames;
program instructions to monitor the data stream during the one or more scheduled time frames for one or more identifiers of the plurality of content to be filtered;
responsive to determining at least one of the one or more identifiers exist in the data stream, program instructions to filter the plurality of content from the data stream;
program instructions to receive a notification that the one or more scheduled time frames has ended;
responsive to receiving a notification that the one or more scheduled time frames has ended, program instructions to retrieve the plurality of content filtered from the data stream; and
program instructions to return the plurality of content to the data stream.

20. The computer system of claim 19, wherein the request to filter content from a data stream includes at least one of:
a request to delay displaying content from the data stream during the scheduled time frame;
a request to ignore content received from the data stream during the scheduled time frame; and
a request to filter one or more aspects of the plurality of content from the data stream, wherein the one or more aspects of the plurality of content include one or more of: a source of the plurality of content, a topic of the plurality of content, and a specific result of the plurality of content.
